(19) United States
(12) Patent Application Publication
(10) Pub. No.: US 2012/0192113 A1
(43) Pub. Date: Jul. 26, 2012

(54) PORTABLE ELECTRONIC DEVICE

(75) Inventor: Takeshi HIGUCHI, Daito-shi (JP)

(73) Assignee: KYOCERA CORPORATION, Kyoto (JP)

(21) Appl. No.: 13/355,772

(22) Filed: Jan. 23, 2012

(30) Foreign Application Priority Data
Jan. 24, 2011 (JP) 2011-012230

(51) Int. Cl. G06F 3/048

(52) U.S. Cl. 715/835

(57) ABSTRACT

A portable electronic device includes a first display part and a second display part. The first display part includes a touch-panel function. The second display part includes a touch-panel function. When the number of icons to be displayed is greater than a threshold value, a control section simultaneously displays a part of the icons to be displayed, in one of display screens of the first display part and the second display part.

### CROSS-REFERENCE TO RELATED APPLICATION

This application is based on application No. JP 2011-12230 filed in Japan, the contents of which are hereby incorporated by reference.

### BACKGROUND OF THE INVENTION

1. Field of the Invention

The present invention relates to a portable electronic device including two display screens that are simultaneously viewable.

2. Description of the Background Art

Conventionally, various techniques related to a portable electronic device have been proposed. For example, Japanese Patent Application Laid-Open No. 2005-218778 discloses a technique related to a portable electronic device including two display screens that are simultaneously viewable.

In a portable electronic device, an icon for launching an application program is sometimes displayed. A user selects the icon displayed on the portable electronic device, and thereby can launch an application program corresponding to the icon in the portable electronic device. When icons for launching application programs are displayed in the portable electronic device including two display screens that are simultaneously viewable as disclosed in Japanese Patent Application Laid-Open No. 2005-218778, the number of icons simultaneously displayable is greater than when icons are displayed in a portable electronic device including a single display screen. This makes it less easy for a user of the portable electronic device including the two display screen that are simultaneously viewable to select a desired icon from a plurality of icons simultaneously displayed on the portable electronic device.

### SUMMARY OF THE INVENTION

A portable electronic device according to an aspect includes: a first display part including a touch-panel function and being operable to display an icon for launching an application program; a second display part including a touch-panel function and being operable to display the icon; and a display control section for controlling displays in the first and second display parts. The display control section performs a display control such that, when the number of the icons to be displayed is greater than a threshold value, a part of the icons to be displayed are simultaneously displayed in one of display screens of the first and second display parts.

A portable electronic device according to an aspect includes: a first display part including a touch-panel function and being operable to display an icon for launching an application program; a second display part including a touch-panel function and being operable to display the icon; a display control section for controlling displays in the first and second display parts; and a display priority determination section for determining a display priority of the icon based on a frequency of launching of the application program corresponding to the icon. The portable electronic device has a first state and a second state, the first state allowing display screens of the first and second display parts to be simultaneously viewed, the second state allowing, from among the display screens of the first and second display parts, only the display screen of the first display part to be viewed. If the first and second display parts are changed from the first state to the second state in a case where the number of the icons to be displayed is greater than a threshold value, the display control section determines the icon which is displayed in the first display part, based on the display priorities of the icons to be displayed.

A portable electronic device according to an aspect includes: a first display part including a touch-panel function and being operable to display an icon for launching an application program; a second display part including a touch-panel function and being operable to display the icon; a display control section for controlling displays in the first and second display parts; an identification section for identifying a kind of place where the portable electronic device is located; and a display priority determination section for determining a display priority of the icon based on the kind of place where the portable electronic device is located, which is identified by the identification section. The portable electronic device has a first state and a second state, the first state allowing display screens of the first and second display parts to be simultaneously viewed, the second state allowing, from among the display screens of the first and second display parts, only the display screen of the first display part to be viewed. If the first and second display parts are changed from the first state to the second state in a case where the number of the icons to be displayed is greater than a threshold value, the display control section determines the icon which is displayed in the first display part, based on the display priorities of the icons to be displayed.

According to the portable electronic device, a user selects a desired icon easily. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an external appearance of a portable electronic device in a closed state according to a preferred embodiment;

FIG. 2 is a perspective view showing an external appearance of the portable electronic device in the closed state according to the preferred embodiment;

FIG. 3 is a perspective view showing an external appearance of the portable electronic device in an open state according to the preferred embodiment;

FIG. 4 is a perspective view showing an external appearance of the portable electronic device in the open state according to the preferred embodiment;

FIG. 5 is a block diagram showing an electrical configuration of the portable electronic device according to the preferred embodiment;

FIG. 6 is a diagram showing an example of displaying in the portable electronic device according to the preferred embodiment;

FIG. 7 is a diagram showing an example displaying in the portable electronic device according to the preferred embodiment;

FIG. 8 is a diagram showing an example displaying in the portable electronic device according to the preferred embodiment;

FIG. 9 is a diagram showing an example displaying in the portable electronic device according to the preferred embodiment;

FIG. 10 is a diagram showing an example displaying in the portable electronic device according to the preferred embodiment;

FIG. 11 is a diagram showing an example displaying in the portable electronic device according to the preferred embodiment;

FIG. 12 is a diagram showing an example displaying in the portable electronic device according to the preferred embodiment;

FIG. 13 is a diagram showing an example displaying in the portable electronic device according to the preferred embodiment;

FIG. 14 is a diagram showing an example displaying in the portable electronic device according to the preferred embodiment;

FIG. 15 is a diagram showing an example displaying in the portable electronic device according to the preferred embodiment;

FIG. 16 is a diagram showing an example displaying in the portable electronic device according to the preferred embodiment;

FIG. 17 is a diagram showing an example displaying in the portable electronic device according to the preferred embodiment;

FIG. 18 is a block diagram showing an electrical configuration of a portable electronic device according to a modification of the preferred embodiment;

FIG. 19 is a diagram showing a situation where a user holds the portable electronic device by his/her right hand;

FIG. 20 is a diagram showing a situation where the user holds the portable electronic device by his/her left hand;

FIG. 21 is a diagram showing an external appearance of the portable electronic device according to the modification of the preferred embodiment;

FIG. 22 is a diagram showing a situation where a first housing of the portable electronic device is held by the user and therefore is lowered;

FIG. 23 is a diagram showing a situation where a second housing of the portable electronic device is held by the user and therefore is lowered; and

FIG. 24 is a diagram showing an example of displaying in the portable electronic device according to the modification of the preferred embodiment.

### DESCRIPTION OF THE PREFERRED EMBODIMENTS

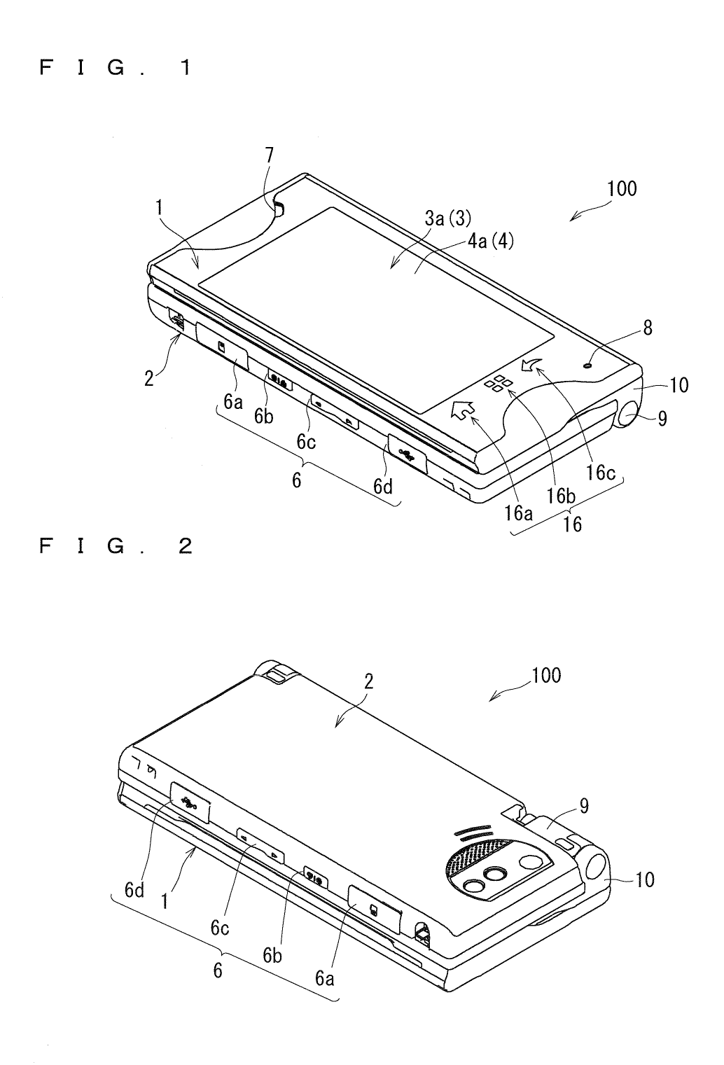

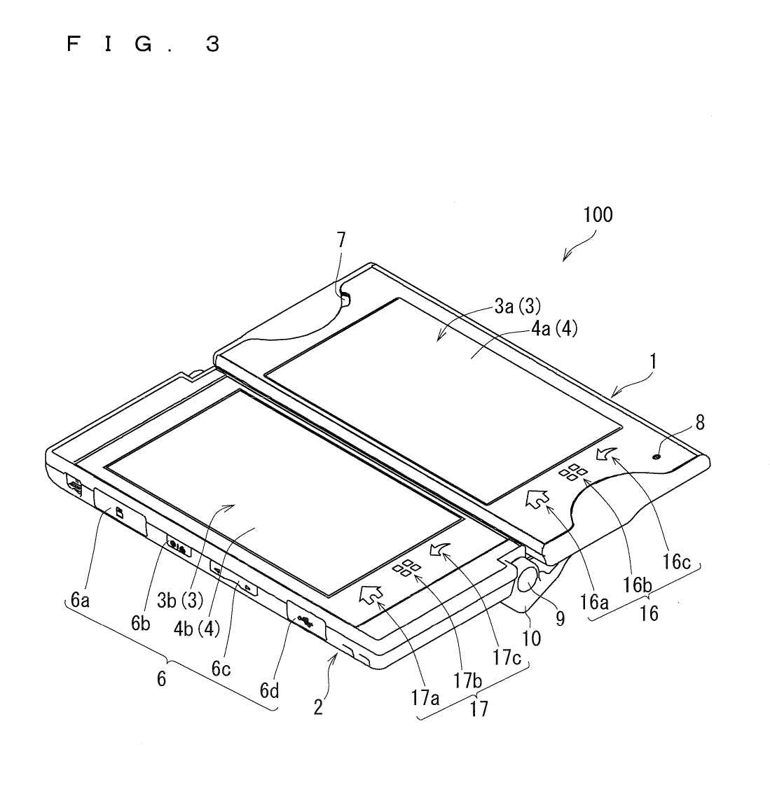

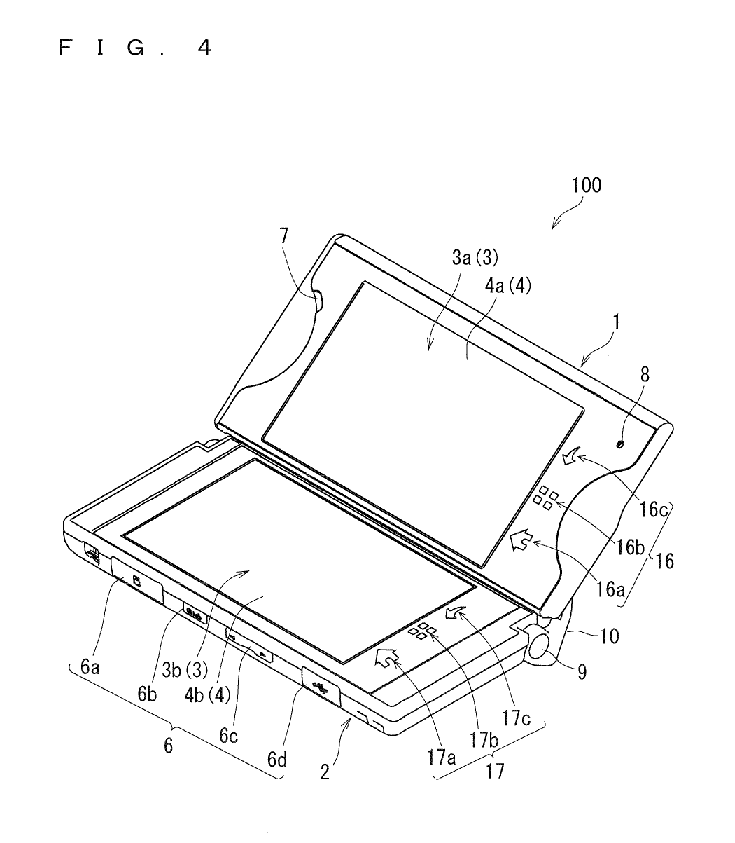

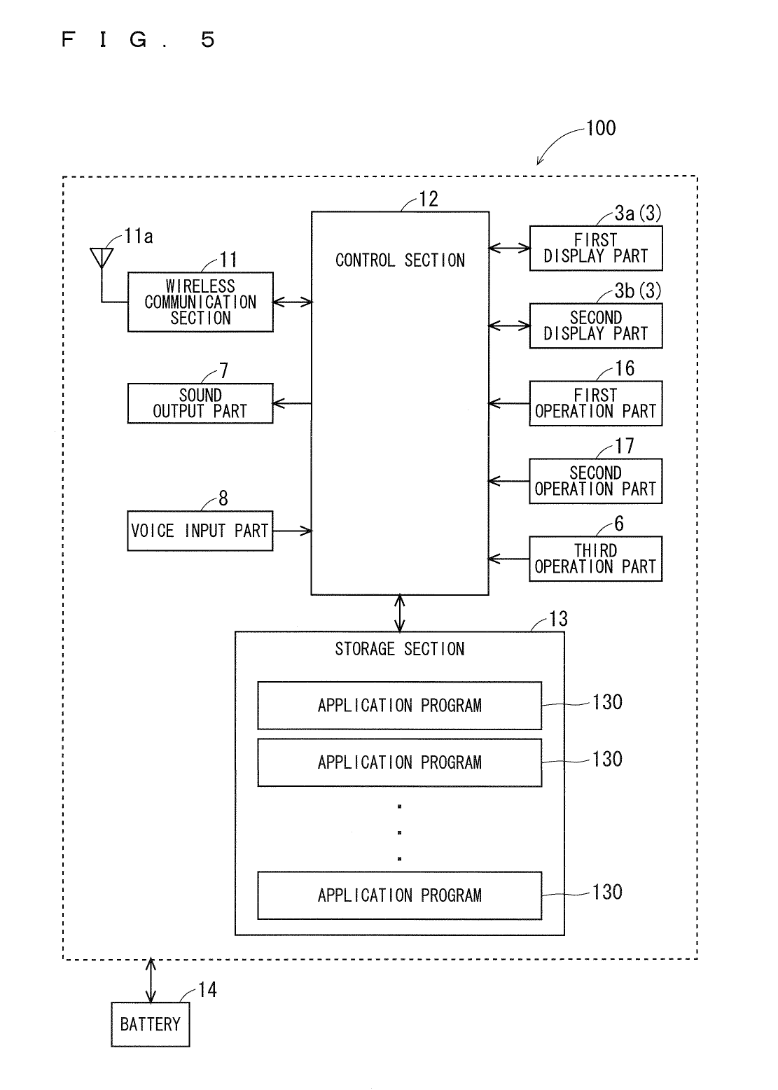

FIGS. 1 to 4 are perspective views showing external appearances of a portable electronic device 100 according to a preferred embodiment. The portable electronic device 100 is, for example, an openable/closable mobile phone, and includes a first housing 1 and a second housing 2. FIG. 1 is a diagram showing the portable electronic device 100 while being closed (in a closed state) as seen from the first housing 1 side, and FIG. 2 is a diagram showing the portable electronic device 100 while being closed as seen from the second housing 2 side. FIGS. 3 and 4 show the portable electronic device 100 while being opened (in an open state).

Here, the state where the portable electronic device 100 is closed means a state where the first housing 1 and the second housing 2 are arranged so as to overlap each other while a first display screen 4a of a first display part 3a provided in the first housing 1 is in a viewable state, as shown in FIGS. 1 and 2. In this case, the first display screen 4a and a second display screen 4b of a second display part 3b provided in a second housing 2 overlap each other with a space interposed therebetween. Therefore, it can be considered that an angle formed therebetween is 0 degree.

On the other hand, the state where the portable electronic device 100 is opened means a state where the first housing 1 and the second housing 2 so as to not overlap each other such that the first display screen 4a of the first display part 3a and the second display screen 4b of the second display part 3b are simultaneously viewable, as shown in FIGS. 3 and 4. In FIG. 3, the portable electronic device 100 is opened such that the first display screen 4a and the second display screen 4b can form 180 degrees, in other words, such that the first display screen 4a and the second display screen 4b can be placed on the same plane. In FIG. 4, the portable electronic device 100 is opened such that the first display screen 4a and the second display screen 4b can form an angle larger than 0 degree and smaller than 180 degrees. Hereinafter, a state where the first display screen 4a and the second display screen 4b are placed on the same plane as shown in FIG. 3 will be referred to as a “flat state”. A state where the first display screen 4a and the second display screen 4b are opened so as to form an angle larger than 0 degree and smaller than 180 degrees as shown in FIG. 4 will be referred to as a “tilt state”.

The first display part 3a has a touch-panel function, and functions as an operation part for receiving an operation made on the first display screen 4a by a user. In the same manner, the second display part 3b has a touch-panel function, and functions as an operation part for receiving an operation made on the second display screen 4b by the user. Hereinafter, in a case where it is not particularly necessary to discriminate the first display part 3a and the second display part 3b from each other, each of them will be called the “display part 3”, and each of the display screens thereof will be called the “display screen 4”.

The first housing 1 and the second housing 2 are coupled to each other by a hinge part 9 and an arm part 10. The hinge part 9 is provided to the second housing 2. The arm part 10 is connected to the hinge part 9 such that an angle of the arm part 10 with respect to the second housing 2 can be changeable. The arm part 10 is also connected to the first housing 1 such that an angle of the arm part 10 with respect to the first housing 1 can be changeable. In the portable electronic device 100, the operation of the hinge part 9 and the arm part 10 allows transition from the closed state shown in FIGS. 1 and 2 to the tilt state shown in FIG. 4, and allows transition from the tilt state shown in FIG. 4 to the flat state shown in FIG. 3. In the portable electronic device 100, the operation of the hinge part 9 and the arm part 10 allows transition from the flat state shown in FIG. 3 to the tilt state shown in FIG. 4, and allows transition from the tilt state shown in FIG. 4 to the closed state shown in FIGS. 1 and 2. Means for coupling the first housing 1 to the second housing 2 is not limited to coupling means including the hinge part 9 and the arm part 10, and coupling means having another configuration may be used to couple the first housing 1 to the second housing 2.

The first housing 1 includes, in addition to the first display part 3a, a sound output part 7, a voice input part 8, and a first operation part 16 for receiving a user operation. The sound output part 7 has a speaker, and the voice input part 8 has a microphone.

The first operation part 16 includes a home key 16a, an option key 16b, and a back key 16c. These keys are provided on a main surface of the first housing 1 at the first display screen 4a side. Each of the keys receives a pressing operation made by the user. The home key 16a is an operation button for displaying a home screen, which will be described later, on the first display screen 4a. The option key 16b is an operation button for displaying a menu screen that enables an option function to be performed during execution of an application program. The back key 16c is an operation button for returning a display of the first display screen 4a to an immediately preceding display. The second housing 2 includes, in addition to the second display part 3b, a second operation part 17 and a third operation part 6 for receiving a user operation. Similarly to the first operation part 16, the second operation part 17 includes a home key 17a, an option key 17b, and a back key 17c. These keys are provided on a main surface of the second housing 1 at the second display screen 4b side. Each of the keys receives a pressing operation made by the user. Functions of the home key 17a, the option key 17b, and the back key 17c are the same as the functions of the home key 16a, the option key 16b, and the back key 16c of the first operation part 16, respectively.

The third operation part 6 includes a plurality of operation buttons 6a to 6d. Each of the plurality of operation buttons 6a to 6d is provided on a side surface of the second housing 2, and receives a pressing operation made by the user.

<Electrical Configuration>

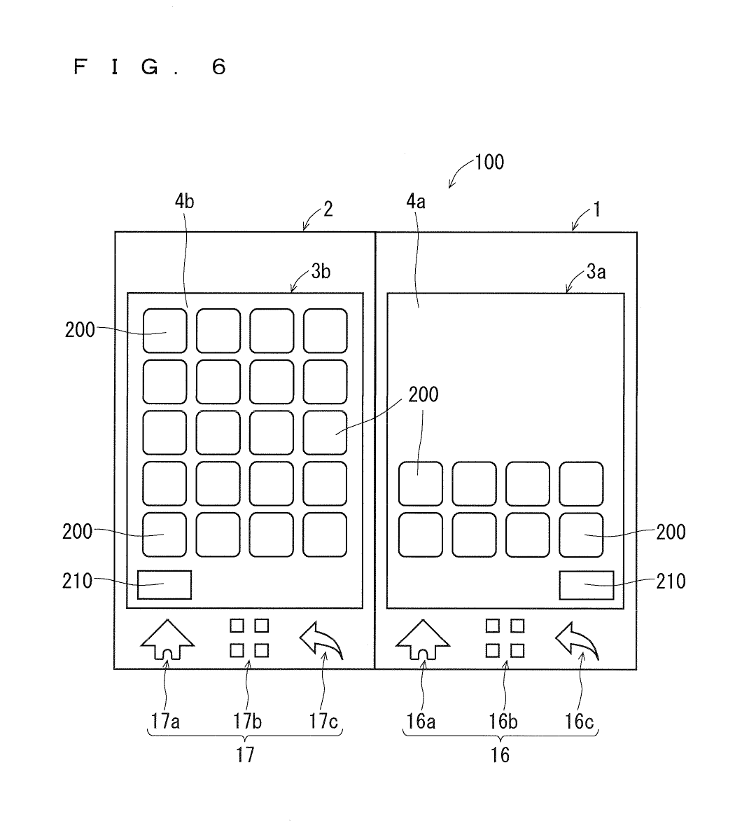

FIG. 5 is a block diagram showing an electrical configuration of the portable electronic device 100. As shown in FIG. 5, the portable electronic device 100 includes not only the first display part 3a, the second display part 3b, the first operation part 16, the second operation part 17, the third operation part 6, the sound output part 7, and the voice input part 8 described above, but also a wireless communication section 11, a control section 12, a storage section 13, and a battery 14.

The control section 12 is configured with a CPU (Central Processing Unit), a DSP (Digital Signal Processor), and the like, and controls other component parts of the portable electronic device 100 to thereby collectively manage an operation of the portable electronic device 100. The control section 12 performs various operations in accordance with the user operations received by the first display part 3a, the second display part 3b, the first operation part 16, the second operation part 17, and the third operation part 6.

The storage section 13 is configured with a ROM (Read Only Memory), a RAM (Random Access Memory), and the like. The storage section 13 stores therein an OS program (not shown), a plurality of application programs 130, and the like. Examples of the application program 130 (hereinafter simply referred to as an “application 130”) include a speech program for enabling voice communication, an e-mail program for enabling transmission and reception of e-mails, a browser for displaying websites, a map display program for displaying maps, a timetable display program for displaying timetables of trains, and an electronic money program for enabling reception of a settlement service using electronic money. The various functions of the control section 12 are implemented by the CPU and the DSP of the control section 12 executing various programs stored in the storage section 13.

The wireless communication section 11 receives, by an antenna 11a, a signal from a communication apparatus such as a mobile phone different from the portable electronic device 100, a web server connected to the internet, and the like, through a base station (not shown). The wireless communication section 11 performs amplification processing and down-conversion on the received signal, and outputs a resulting signal to the control section 12. The control section 12 performs demodulation processing and the like on the received signal inputted thereto, to obtain various data such as voice data and image data included in the received signal. The wireless communication section 11 performs up-conversion and amplification processing on a transmission signal including voice data and the like which is generated by the control section 12, and wirelessly transmits, by the antenna 11a, a resulting transmission signal having the processing performed thereon to a mobile phone different from the portable electronic device 100 or a communication apparatus connected to the internet.

The sound output part 7 converts sound data such as voice data and music data supplied from the control section 12 into a sound, and outputs the resulting sound to the outside. The voice input part 8 converts a voice inputted from the outside into voice data, and outputs the resulting voice data to the control section 12.

The first display part 3a and the second display part 3b have similar configurations. Each display part 3 is, for example, a liquid crystal display part of backlight type for a color display, and includes a liquid crystal display panel and a backlight for emitting a light thereto. Under control of the control section 12, each display part 3 displays various information such as characters, signs, and graphics. The display part 3 may be a display part other than the liquid crystal display part. For example, the display part 3 may be an organic EL display, or may be a display part having a plurality of LEDs arranged in a matrix.

The battery 14 generates a power source of the portable electronic device 100. The power source generated by the battery 14 is supplied to electronic components included in the wireless communication section 11, the control section 12, and the like, in the portable electronic device 100.

<Display of Icon>

In the portable electronic device 100 according to the preferred embodiment, under control of the control section 12, each display part 3 can display an icon (hereinafter referred to as an “application icon”) for launching the application 130 stored in the storage section 13.

In the preferred embodiment, not all the application icons corresponding to all the applications 130 stored in the storage section 13 are displayed. In the preferred embodiment, it is possible to limit the launch of the application 130. An application icon corresponding to the application 130 whose launch is limited is not displayed. By operating the first display screen 4a or the second display screen 4b, the user can limit the launch of any desired application 130. Hereinafter, if not otherwise specified, the term “application icon” means an application icon corresponding to the application 130 whose launch is not limited, that is an application icon to be displayed in the portable electronic device 100.

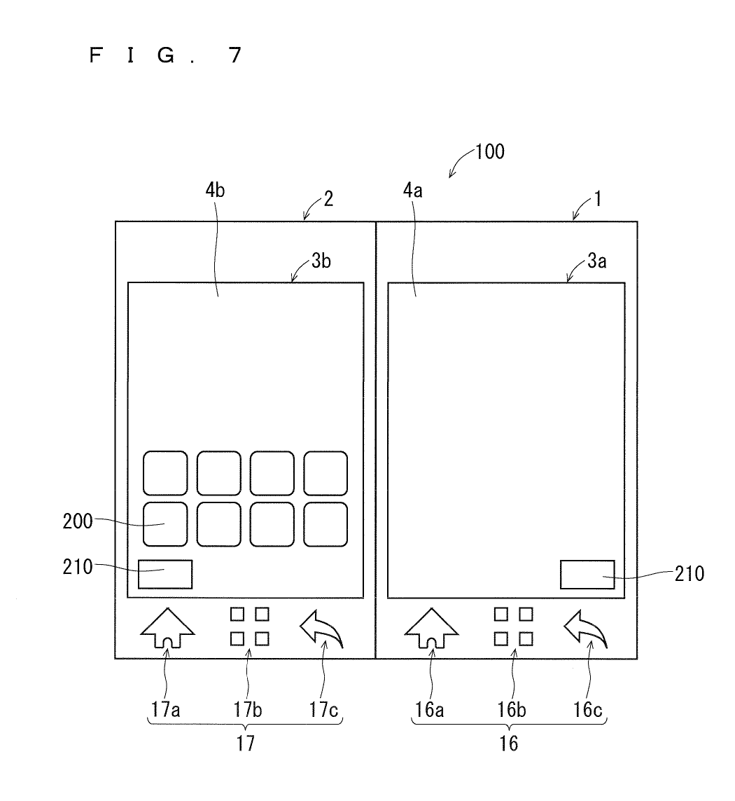

FIG. 6 is a diagram showing an example of a home screen (initial screen) displayed in the portable electronic device 100 in the open state (the flat state or the tilt state). In FIG. 6, the structure of the portable electronic device 100 is simplified. It is to be noted that the structure of the portable electronic device 100 is simplified in the subsequent drawings, too.

When the home key 16a of the first operation part 16 and the home key 17a of the second operation part 17 are operated, the home screen is displayed across the first display screen 4a and the second display screen 4b.

In the example shown in FIG. 6, a plurality of application icons 200 are displayed in each of the first display part 3a and the second display part 3b that display the home screen. A mode switch button 210 displayed in each display part 3 will be described in detail later.

If the user performs an operation for selecting a certain application icon 200 displayed in the display part 3, the control section 12 reads out an application 130 corresponding to this application icon 200 from the storage section 13, and executes the application 130. As a result, the application 130 corresponding to the application icon 200 selected by the user is launched. The operation for selecting the application icon 200 is, for example, a tapping operation that means an operation of touching and then quickly moving away from the display screen.

For example, if an application icon 200 corresponding to the speech program is selected, the control section 12 reads out the speech program from the storage section 13, and executes the speech program. When the speech program is launched, under control of the control section 12, the wireless communication section 11 performs voice communication with another mobile phone or the like.

If an application icon 200 corresponding to the e-mail program is selected, the control section 12 reads out the e-mail program from the storage section 13, and executes the e-mail program. When the e-mail program is launched, under control of the control section 12, the wireless communication section 11 transmits an e-mail to another mobile phone or the like, or receives an e-mail from another mobile phone or the like.

If an application icon 200 corresponding to the browser is selected, the control section 12 reads out the browser from the storage section 13, and executes the browser. When the browser is launched, under control of the control section 12, the wireless communication section 11 performs communication with the web server. Then, under control of the control section 12, a web page received by the wireless communication section 11 from the web server is displayed across the first display part 3a and the second display part 3b.

If an application icon 200 corresponding to the map display program is selected, the control section 12 reads out the map display program from the storage section 13, and executes the map display program. When the map display program is launched, the control section 12 displays a map across the first display part 3a and the second display part 3b based on map information stored in the storage section 13.

If an application icon 200 corresponding to the timetable display program is selected, the control section 12 reads out the timetable display program from the storage section 13, and executes the timetable display program. When the timetable display program is launched, the control section 12 displays a timetable across the first display part 3a and the second display part 3b based on timetable information stored in the storage section 13.

If an application icon 200 corresponding to the electronic money program is selected, the control section 12 reads out the electronic money program from the storage section 13, and executes the electronic money program. When the electronic money program is launched, the control section 12 displays a screen for receiving the settlement service using electronic money in the first display part 3a and the second display part 3b.

In a case where the portable electronic device 100 is used in the closed state, the home screen including the application icons 200 is displayed on only the first display screen 4a that is viewable to the user.

As shown in FIG. 6, while the portable electronic device 100 is in the open state, the application icons 200 can be displayed on both the first display screen 4a and the second display screen 4b. Therefore, may application icons 200 can be simultaneously displayed in the portable electronic device 100 in the open state. If the portable electronic device 100 simultaneously displays many application icons 200, it may be sometimes less easy for the user to select a desired application icon 200.

Therefore, the preferred embodiment makes it possible to limit the number of application icons 200 simultaneously displayed in the portable electronic device 100, thus making it easy for the user to select a desired application icon 200. In the following, this process in the portable electronic device 100 will be described in detail.

The control section 12, which functions as a display control section for controlling the display of each display part 3, has a limited-number-of-displayed-icons mode in which the number of application icons 200 simultaneously displayed is limited, and a normal icon display mode in which the number of icons 200 simultaneously displayed is not limited.

<Normal Icon Display Mode>

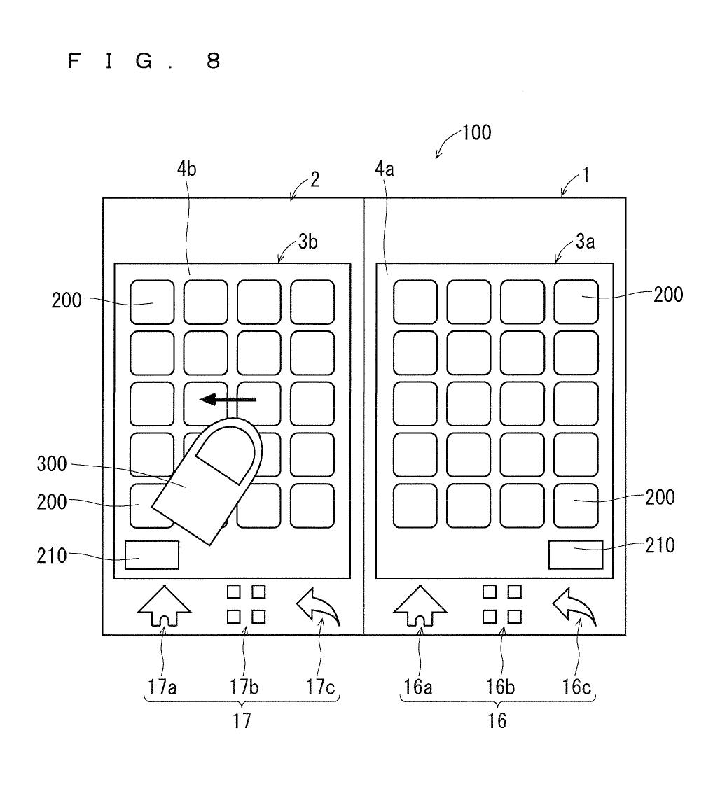

In the normal icon display mode, for example, as shown in FIG. 7, the application icons 200 are displayed from a bottom portion (a lower end portion when viewed from the user's position) of the second display screen 4b. If the number of application icons 200 increases because, for example, the wireless communication section 11 downloads the applications 130 from an external apparatus so that the number of application icons 200 (in this example, 20 icons) displayable on the second display screen 4b is exceeded, the excessive application icons 200 not displayable on the second display screen 4b are displayed on the first display screen 4a from a bottom portion thereof, as shown in FIG. 6 mentioned above.

Then, if the number of application icons 200 further increases to make it impossible to simultaneously display all of them on the first display screen 4a and the second display screen 4b (in this example, if the number of application icons 200 exceeds 40), the excessive application icons 200 not displayable are displayed by switching a page of the home screen displayed by the first display part 3a and the second display part 3b. In the preferred embodiment, by operating the first display screen 4a or the second display screen 4b, the page of the home screen displayed in the first display part 3a and the second display part 3b can be switched.

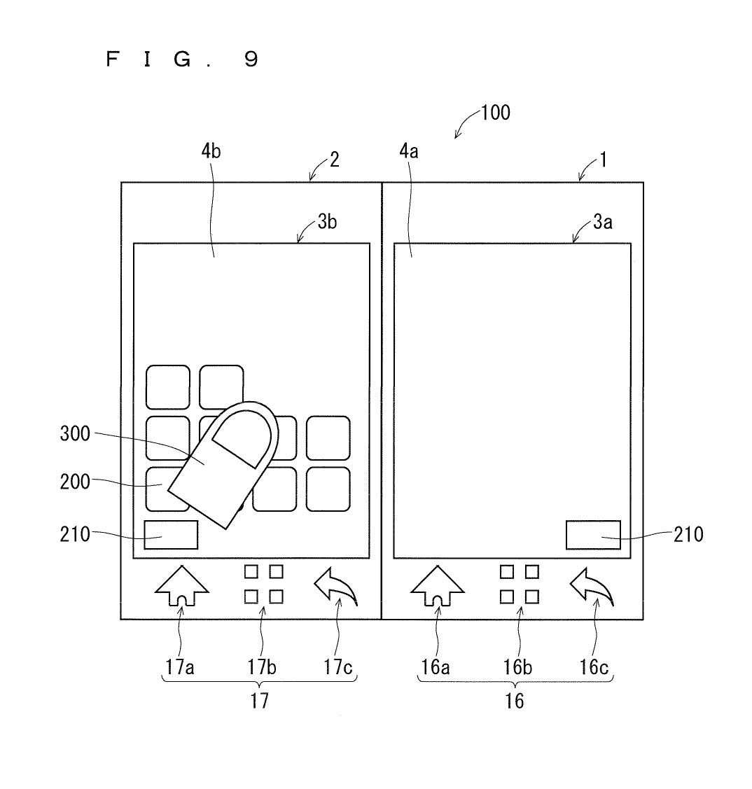

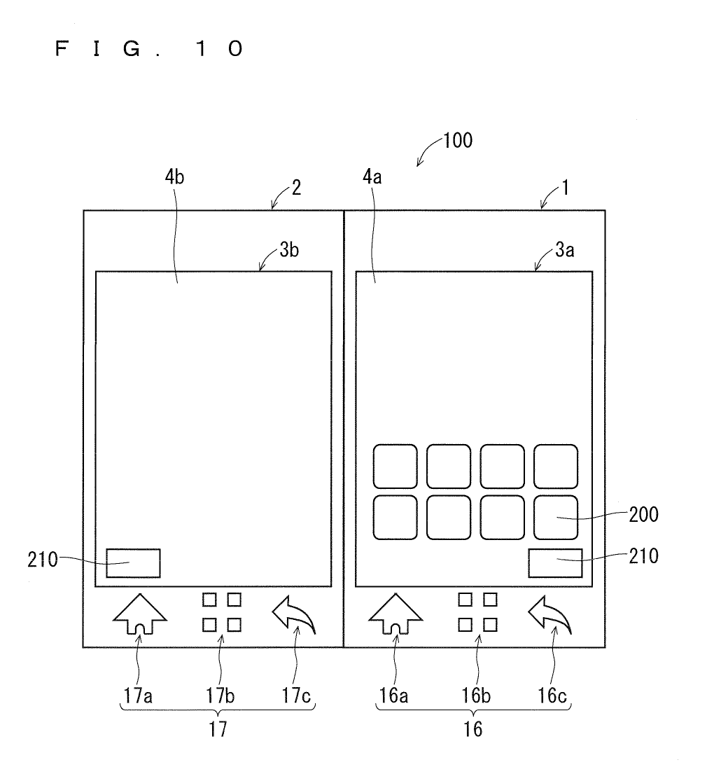

For example, as shown in FIG. 8, in a case where the user touches the second display screen 4b with his/her finger 300 and in this condition performs an operation (flick) of sweeping the finger 300 to the left (the left side when viewed from the user's position) while the maximum number of application icons 200 are displayed on the respective display screens 4, as shown in FIG. 9, the page of the home screen is switched to the next page, so that the application icons 200 not displayed in the initial page are displayed in the next page. In an example shown in FIG. 9, the number of application icons 200 not displayed in the initial page is 10 which is less than 20, and therefore, in the next page, the ten application icons 200 are displayed in only the second display part 3b.

Likewise, in a case where the user touches the first display screen 4a with his/her finger and in this condition performs an operation of sweeping the finger to the left, the page of the home screen displayed in the first display part 3a and the second display part 3b is switched to the next page, so that the application icons 200 not displayed in the initial page are displayed in the next page.

In this manner, in the preferred embodiment, even if the number of application icons 200 is greater than the number of icons (in this example, 40 icons) simultaneously displayed in the portable electronic device 100, the page of the home screen displayed in the portable electronic device 100 is switched, and thereby all the application icons 200 can be displayed.

A display position of the application icon 200 can be changed by the user. In order to change a display position of a certain application icon 200 displayed on the display screen 4, the user touches this application icon 200 with his/her finger and in this condition moves the finger to an area on the display screen 4 where no application icon 200 is displayed. As a result, the application icon 200 is displayed at a position to which the finger has been moved. If the user touches an application icon 200 displayed in a certain page of the home screen with his/her finger and in this condition moves the finger to the right edge of the page, this application icon 200 is displayed in the next page.

<Limited-Number-of-Displayed-Icons Mode>

As shown in FIGS. 6 to 9 mentioned above, in each of the first display part 3a and the second display part 3b that display the home screen, the mode switch button 210 is displayed on the corresponding display screen 4. If either one of the mode switch buttons 210 displayed on the first display part 3a and the second display part 3b is operated, the control section 12 operating in the normal icon display mode is caused to operate in the limited-number-of-displayed-icons mode.

In the limited-number-of-displayed-icons mode, the control section 12 compares the current number of application icons 200 with a predetermined threshold value. The threshold value is set, for example, to be equal to or less than the number of application icons 200 (in this example, 20 icons) displayable in one display part 3. In the preferred embodiment, the threshold value is set to be 8 (displayable in two rows).

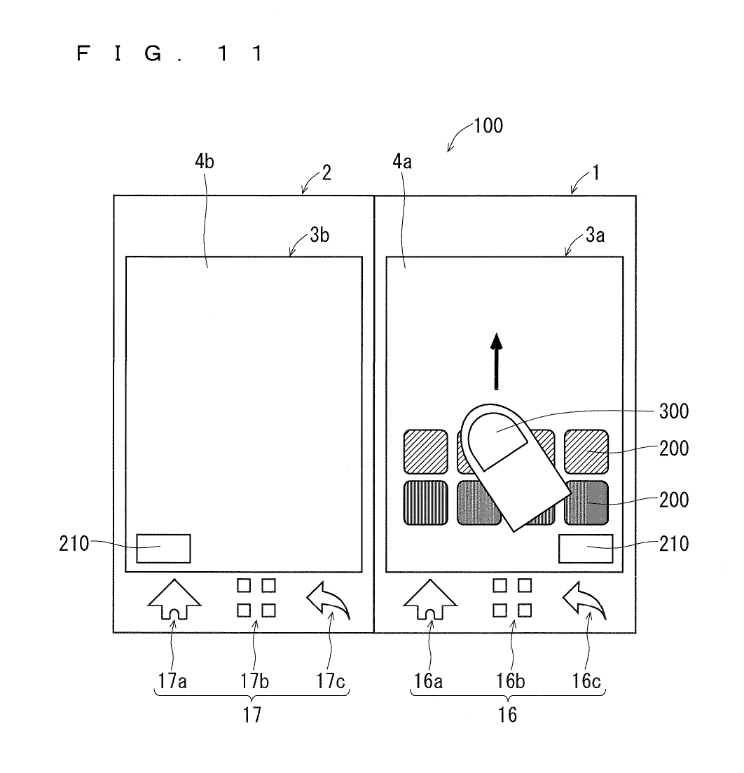

If the number of application icons 200 is equal to or less than the threshold value, the control section 12 simultaneously displays all of the application icons 200 in, from among the first display part 3a and the second display part 3b, only the display part 3 that displays the mode switch button 210 operated by the user. At this time, similarly to the normal icon display mode, each display part 3 displays the mode switch button 210. Accordingly, if the mode switch button 210 displayed in the second display part 3b is operated while the control section 12 is operating in the normal icon display mode and the display as shown in FIG. 7 mentioned above is appearing in the portable electronic device 100, the displays in the first display part 3a and the second display part 3b do not change. On the other hand, if the mode switch button 210 displayed in the first display part 3a is operated while the control section 12 is operating in the normal icon display mode and the display as shown in FIG. 7 is appearing in the portable electronic device 100, the application icons 200 are caused to be displayed in only the first display part 3a, as shown in FIG. 10.

If the number of application icons 200 is greater than the threshold value, the control section 12 simultaneously displays a part of the application icons 200 in, from among the first display part 3a and the second display part 3b, only the display part 3 that displays the mode switch button 210 operated by the user. In the preferred embodiment, application icons 200, the number of which is equal to the threshold value, are simultaneously displayed in only the display part 3 that displays the mode switch button 210 operated by the user.

For example, if the mode switch button 210 displayed in the second display part 3b is operated while the control section 12 is operating in the normal icon display mode and the display as shown in FIG. 6 mentioned above is appearing in the portable electronic device 100, eight application icons 200 from among the application icons 200 to be displayed are simultaneously displayed in only the second display part 3b, as shown in FIG. 7. If the mode switch button 210 displayed in the first display part 3a is operated while the control section 12 is operating in the normal icon display mode and the display as shown in FIG. 6 mentioned above is appearing in the portable electronic device 100, eight application icons 200 from among the application icons 200 to be displayed are simultaneously displayed in only the first display part 3a, as shown in FIG. 10.

It may be acceptable that, if the number of application icons 200 is greater than the threshold value, application icons 200, the number of which is less than the threshold value, may be simultaneously displayed in only the display part 3 that displays the mode switch button 210 operated by the user.

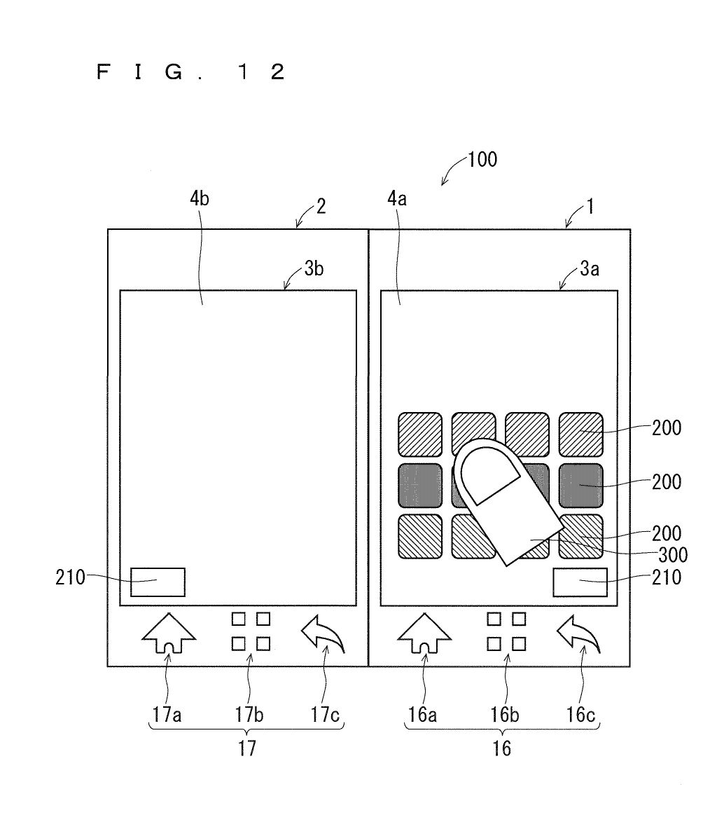

The rest of the application icons 200 to be displayed can be displayed by scrolling the home screen. For example, as shown in FIG. 11, the user touches, with the finger 300, the first display screen 4a that displays two rows of application icon 200 (eight icons), and in this condition, moves the finger 300 upward. This makes the home screen scrolled upward, so that a next row of application icons 200 is displayed at the bottom portion of the first display screen 4a, as shown in FIG. 12. If the user moves the finger 300 touching on the first display screen 4a further upward, the home screen is scrolled upward. Thus, if there is any application icon 200 not displayed, a further next row of application icons 200 is displayed in the bottom portion of the first display screen 4a. In FIGS. 11 and 12, the application icons 200 are hatched in different manners depending on rows, in order that the scrolling of the home screen can be understood. If the user moves the finger 300 touching on the first display screen 4a downward, the home screen is scrolled downward.

In this manner, in the preferred embodiment, if the mode of the control section 12 is switched from the normal icon display mode to the limited-number-of-displayed-icons mode in a case where the number of application icons 200 to be displayed is greater than the threshold value, a part of the application icons 200 to be displayed are simultaneously displayed in one display part 3. Then, by operating the display screen 4 of the display part 3 to thereby scroll the home screen, all of the application icons 200 to be displayed can be displayed in the display part 3.

In the preferred embodiment, if, while the control section 12 is operating in the limited-number-of-displayed-icons mode, the home screen is no longer displayed and then the home screen is displayed again due to, for example, an operation being made in the first operation part 16 and the second operation part 17, the control section 12 compares the application icon 200 with the threshold value again. If the number of application icons 200 is equal to or less than the threshold value, similarly to the manner described above, the control section 12 simultaneously displays all of the application icons 200 in the display part 3 that displays the mode switch button 210 having been operated for switching the mode of the control section 12 to the limited-number-of-displayed-icons mode. On the other hand, if the number of application icons 200 is greater than the threshold value, similarly to the manner described above, the control section 12 simultaneously displays a part of the application icons 200 in the display part 3 that displays the mode switch button 210 having been operated for switching the mode of the control section 12 to the limited-number-of-displayed-icons mode.

In the preferred embodiment, if the number of application icons 200 is changed while the control section 12 is operating in the limited-number-of-displayed-icons mode and the portable electronic device 100 is displaying the home screen, the control section 12 compares the number of application icons 200 with the threshold value again. Then, if the number of application icons 200 is equal to or less than the threshold value, similarly to the manner described above, the control section 12 simultaneously displays all of the application icons 200 in one display part 3. On the other hand, if the number of application icons 200 is greater than the threshold value, similarly to the manner described above, the control section 12 simultaneously displays a part of the application icons 200 in one display part 3.

In the preferred embodiment, if the user operates the display screen 4 in the display part 3 different from the display part 3 that displays the application icon 200 while the control section 12 is operating in the limited-number-of-displayed-icons mode and the portable electronic device 100 is displaying the home screen, the control section 12 causes the application icons 200 to be displayed in the different display part 3. For example, in a case where the first display part 3a displays the application icons 200 as shown in FIG. 10, if the second display screen 4b of the second display part 3b is operated, the display part 3 for displaying the application icons 200 is switched. Thus, as shown in FIG. 7, the application icons 200 are displayed in the second display part 3b.

In the preferred embodiment, if either one of the mode switch buttons 210 displayed in the first display part 3a and the second display part 3b that display the home screen is operated while the control section 12 is operating in the limited-number-of-displayed-icons mode, the control section 12 is caused to operate in the normal icon display mode.

In the example described above, all of the application icons 200 to be displayed can be displayed by scrolling the home screen. However, similarly to the normal icon display mode, all of the application icons 200 to be displayed can be displayed by switching the page of the home screen.

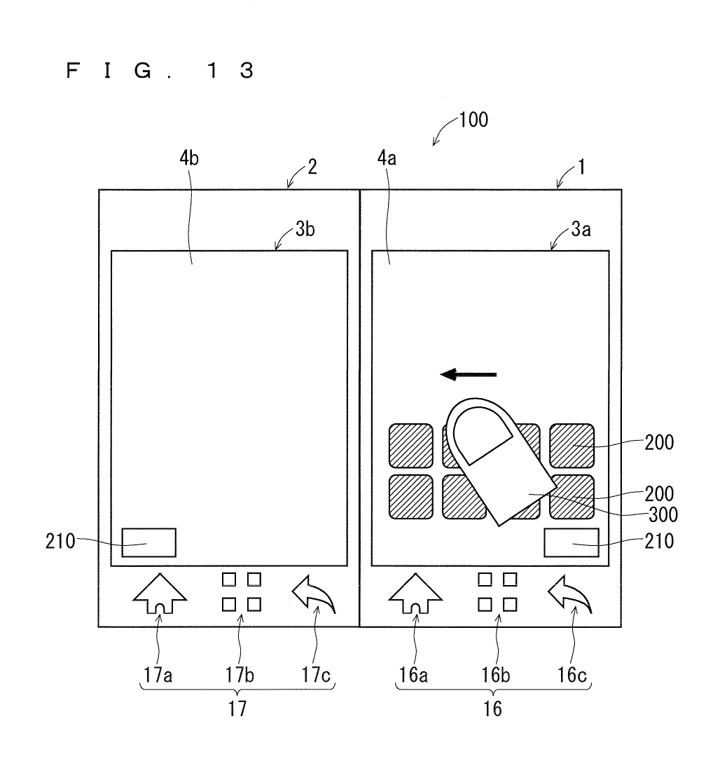

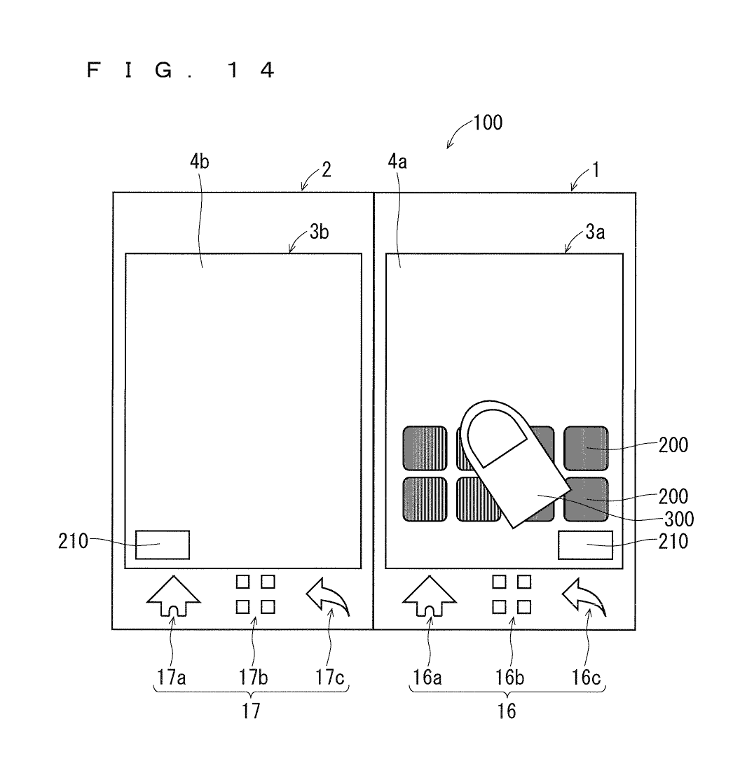

For example, as shown in FIG. 13, if the user flicks the first display screen 4a to the left, the page of the home screen is switched to the next page, so that application icons 200 not displayed in the initial page are displayed in the next page, as shown in FIG. 14. In FIGS. 13 and 14, the application icons 200 are hatched in different manners depending on pages of the home screen, in order that the switching of the page of the home screen can be understood. In this example, in pages of the home screen other than the initial page, the maximum number of application icons 200 displayed is eight. Accordingly, when the page is switched, if the number of application icons 200 left is equal to or greater than eight, eight application icons 200 are displayed in the display part 3 as shown in FIG. 14, and if the number of application icons 200 left is less than eight, less than eight application icons 200 are displayed in the display part 3.

As described above, in the limited-number-of-displayed-icons mode according to the preferred embodiment, if the number of application icons 200 is greater than the threshold value, a part thereof is simultaneously displayed in only one display part 3 from among the first display part 3a and the second display part 3b. This makes it easy for the user to select a desired application icon 200.

<Method for Determining Application Icon to be Displayed in Limited-Number-of-Displayed-Icons Mode>

Next, a description will be given to a method for determining a plurality of application icons 200 to be simultaneously displayed in the display part 3 in a case where the number of application icons 200 is greater than the threshold value in the limited-number-of-displayed-icons mode.

In the preferred embodiment, the control section 12 sets a display priority for each application icon 200 to be displayed. Then, in the limited-number-of-displayed-icons mode, if the number of application icons 200 is greater than the threshold value, the control section 12 displays the application icons 200 in the display part 3 in descending order of the display priority.

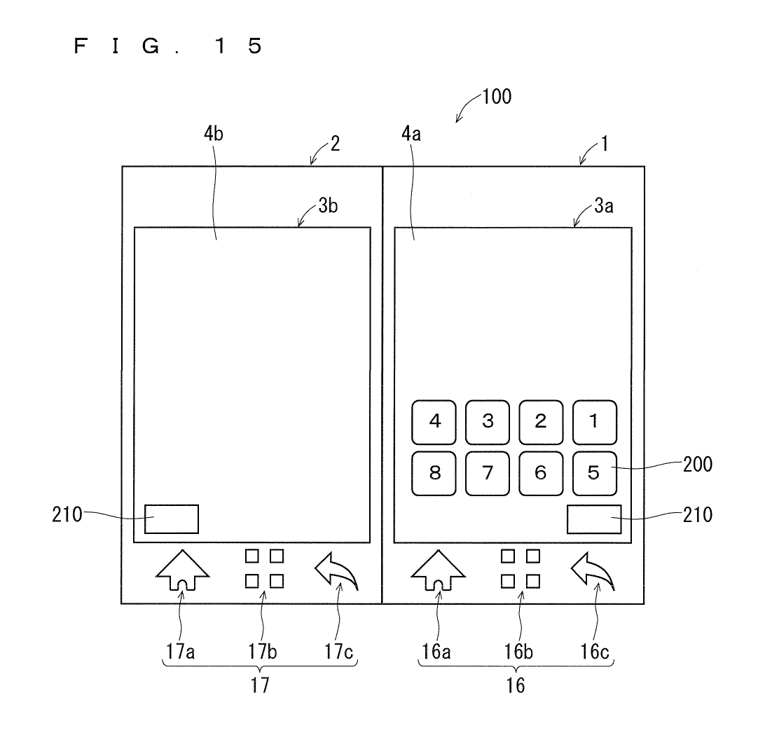

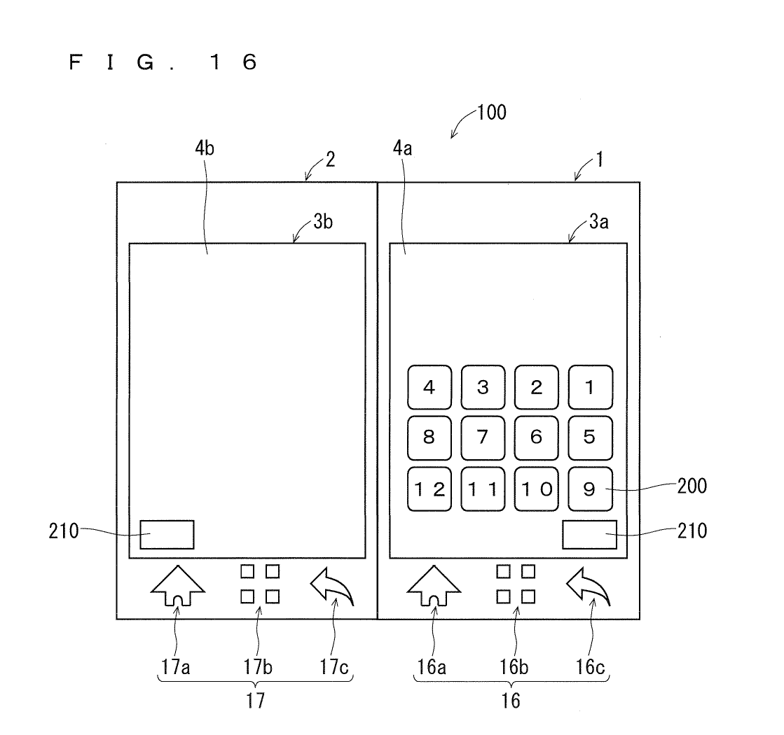

The control section 12 operating in the limited-number-of-displayed-icons mode compares the number of application icons 200 with the threshold value, and if the number of application icons 200 is greater than the threshold value, the control section 12 selects, in descending order of the display priority, eight application icons 200 from the plurality of application icons 200 to be displayed, and displays the eight application icons 200 in the display part 3. FIG. 15 is a diagram showing a situation where the eight application icons 200 are displayed in the first display part 3a. In FIG. 15 and FIGS. 16, 17, and 24 which will be mentioned later, the display priority of each application icon 200 is shown in the square representing this application icon 200. In the preferred embodiment, the display priority represented by a smaller number has a higher display priority.

If the user touches the first display screen 4a shown in FIG. 15 with his/her finger and in this condition moves the finger upward, the home screen is scrolled upward, so that application icons 200 having higher display priorities, from among the left application icons 200, are displayed on the first display screen 4a. FIG. 16 is a diagram showing a situation where, as a result of scrolling the home screen of FIG. 15 upward, four application icons 200 having the next higher display priorities are displayed in the first display part 3a. In this manner, by scrolling the home screen upward, the plurality of application icons 200 to be displayed are displayed in descending order of the display priority.

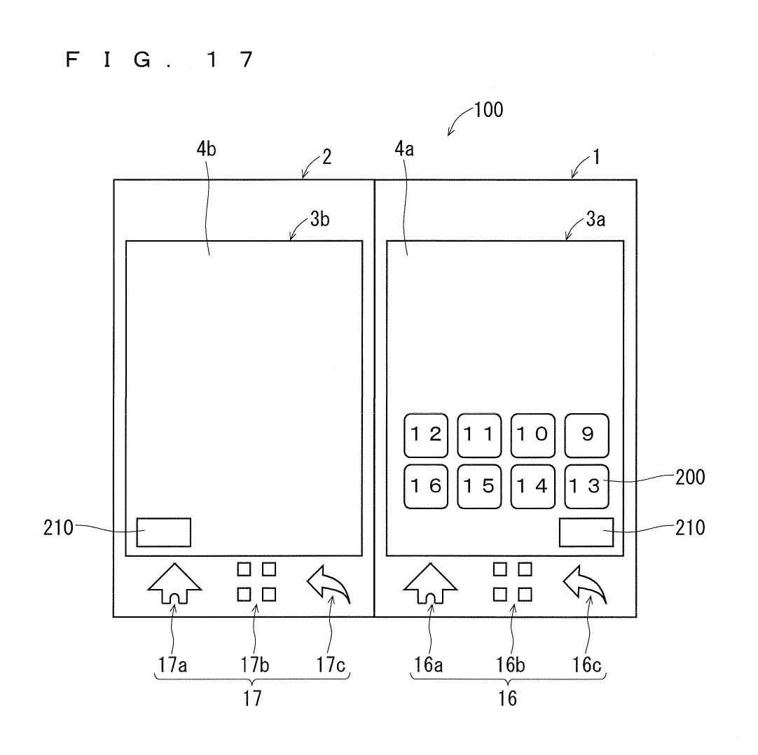

In a case where all of the application icons 200 to be displayed can be displayed by switching the page of the home screen as shown in FIGS. 13 and 14 mentioned above, the plurality of application icons 200 to be displayed are displayed in descending order of the display priority by switching the page of the home screen. FIG. 17 is a diagram showing a situation where the next page of the home screen is displayed on the first display screen 4a as a result of the user flicking the first display screen 4a of FIG. 15 to the left.

<Method for Determining Display Priority>

The display priority of each application icon 200 can be determined based on various viewpoints. In the following, regarding a method for determining the display priority, a plurality of examples will be described.

### First Example

In this example, the display priority of the application icon 200 is set such that a higher display priority can be given to an application icon 200 that corresponds to an application 130 more frequently launched. In this case, the control section 12 creates a launch frequency list indicating the frequency of launching of each application 130, and stores the launch frequency list in the storage section 13. When the application 130 is launched, the control section 12 updates the launch frequency list in the storage section 13. When displaying the home screen in the display part 3, the control section 12 refers to the launch frequency list, and sets the display priorities such that a higher display priority can be given to an application icon 200 corresponding to an application 130 more frequently launched. The control section 12 functions as a display priority determination section for determining a display priority of an application icon 200 based on the frequency of launching of an application 130 that corresponds this application icon 200. For example, in a case where the frequency of launching decreases in the order of the e-mail program, the browser, the speech program, the map display program, the timetable display program, and the electronic money program, the control section 12 sets display priorities of application icons 200 corresponding to these applications 130 such that the display priority can decrease in this order.

In this manner, the display priority of the application icon 200 is set such that a higher display priority can be given to an application icon 200 that corresponds to an application 130 more frequently launched. Thereby, in the home screen, an application icon 200 that corresponds to an application 130 more frequently launched is displayed first. This makes it easy for the user to select the application icon 200 that is more frequently selected.

### Second Example

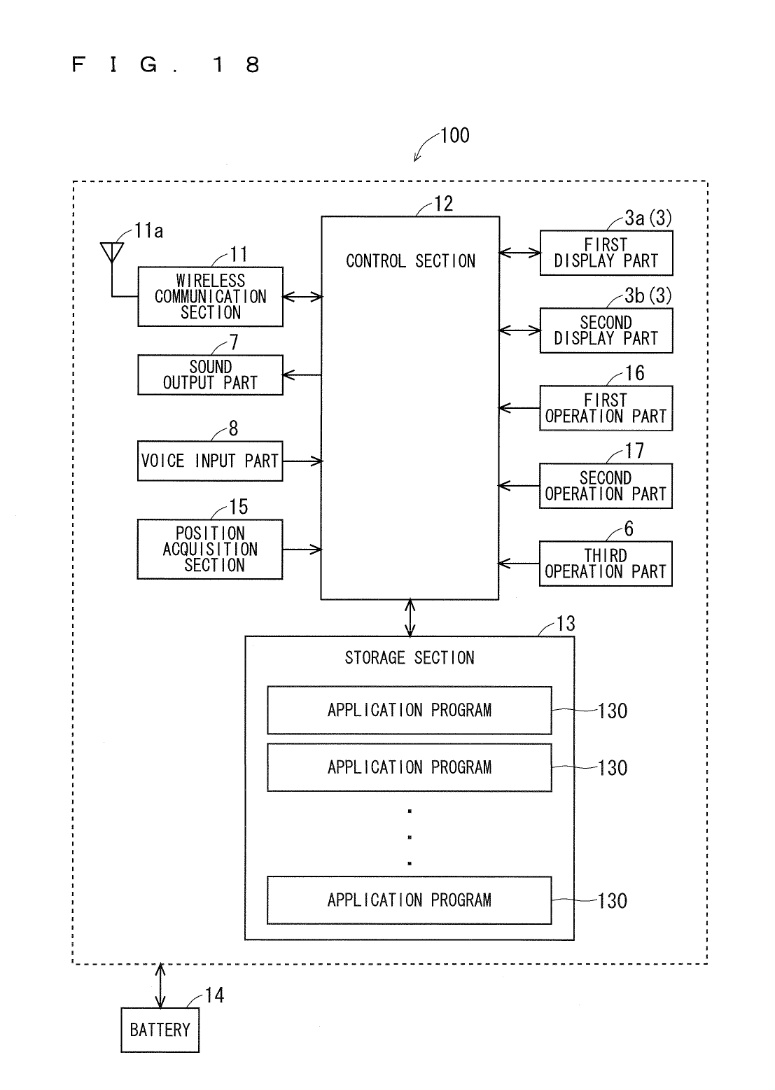

In this example, if a kind of place where the portable electronic device 100 is located indicates a particular kind, the highest display priority is given to the application icon 200 for launching the application 130 concerning this particular kind. In this case, as shown in FIG. 18, a position acquisition section 15 for obtaining a position is provided in the portable electronic device 100. For example, the position acquisition section 15 is configured as a GPS receiver for receiving signals from a plurality of satellites of a GPS (Global Positioning System) and calculating a position of the portable electronic device 100 based on the received signals. Then, the control section 12 identifies the kind of place where the portable electronic device 100 is located, based on the position of the portable electronic device 100 obtained by the position acquisition section 15 and the map information stored in the storage section 13. For example, the control section 12 identifies the kind of place where the portable electronic device 100 is located, as “station” or as “convenience store”.

In this manner, the position acquisition section 15 and the control section 12 function as an identification section for identifying the kind of place where the portable electronic device 100 is located.

The storage section 13 stores a table in which a kind of place is associated with an application 130 that is likely to be launched in the kind of place. In this table, for example, “station” and “timetable display program” are associated with each other, and “convenience store” and “electronic money program” are associated with each other.

If the kind of place where the portable electronic device 100 is located corresponds to any of the kinds of place described in the table stored in the storage section 13, the control section 12 gives the highest display priority to the application icon 200 corresponding to the application 130 concerning this kind of place. For example, if the kind of place where the portable electronic device 100 is located corresponds to “station” described in the table stored in the storage section 13, the control section 12 gives the highest display priority to the application icon 200 that corresponds to the timetable display program associated with “station”. If the kind of place where the portable electronic device 100 is located corresponds to “convenience store” described in the table stored in the storage section 13, the control section 12 gives the highest display priority to the application icon 200 that corresponds to the electronic money program associated with “convenience store”. Thus, the application icon 200 that is likely to be selected at a current place by the user carrying the portable electronic device 100 can be displayed in the portable electronic device 100. This makes it easy for the user to select a desired application icon 200.

With respect to, from among the application icons 200 to be displayed, the application icons 200 other than the application icon 200 that corresponds to the application 130 concerning the kind of place where the portable electronic device 100 is located, the same display priority may be given, or a higher display priority may be given to an application icon 200 corresponding to an application 130 more frequently launched in the same manner as described above.

In this manner, in this example, the control section 12 and the storage section 13 function as a display priority determination section for determining the display priority of the application icon 200 based on the kind of place where the portable electronic device 100 is located.

Although in the example described above, one application 130 is associated with one kind of place, a plurality of applications 130 may be associated therewith. For example, since the e-mail program is likely to be launched in “station”, “timetable display program” and “e-mail program” may be associated with “station”.

### Third Example

In this example, the user is allowed to set a display priority of each application icon 200. More specifically, the user can set a display priority of each application icon 200 by operating the display screen 4 of at least one of the first display part 3a and the second display part 3b. The display priority set by the user is stored in the storage section 13. The control section 12 operating in the limited-number-of-displayed-icons mode refers to the storage section 13 for the display priority of each application icon 200, and displays application icons 200 having higher display priorities in the display part 3.

### Various Modifications

Hereinafter, various modifications of the preferred embodiment will be described.

### First Modification

In the limited-number-of-displayed-icons mode described above, the application icons 200 may be displayed in the display part 3 provided in one of the first housing 1 and the second housing 2 that is held by the hand of the user.

For example, if the mode switch button 210 displayed in one of the display parts 3 is operated while the control section 12 is operating in the normal icon display mode, the application icons 200 are not necessarily displayed in the one display part 3, but the application icons 200 are displayed in the display part 3 provided in one of the first housing 1 and the second housing 2 that is held by the hand of the user at the time when the mode switch button 210 is operated.

If, while the control section 12 is operating in the limited-number-of-displayed-icons mode, the home screen is no longer displayed and then the home screen is displayed again due to, for example, an operation being made in the first operation part 16 and the second operation part 17, the application icons 200 are displayed in the display part 3 provided in the housing held by the hand of the user at this point of time.

If the housing held by the user is changed while the control section 12 is operating in the limited-number-of-displayed-icons mode and the portable electronic device 100 is displaying the home screen, the application icons 200 are displayed in the display part 3 provided in the housing newly held by the user.

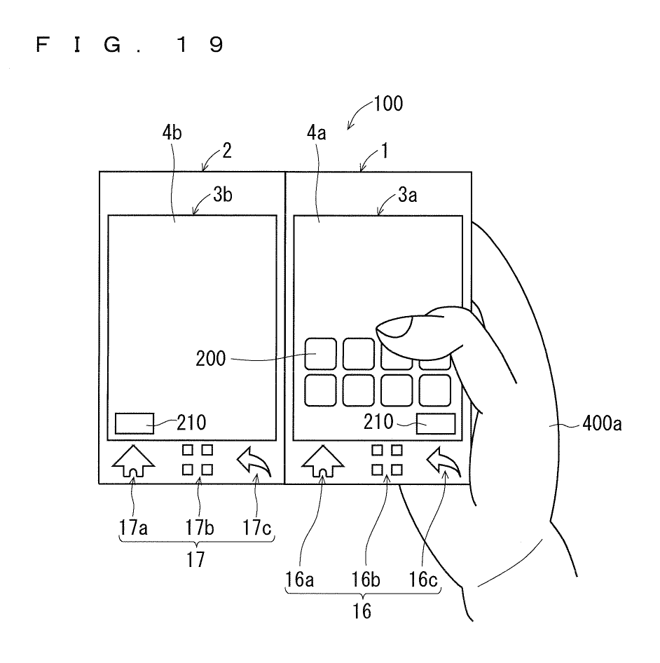

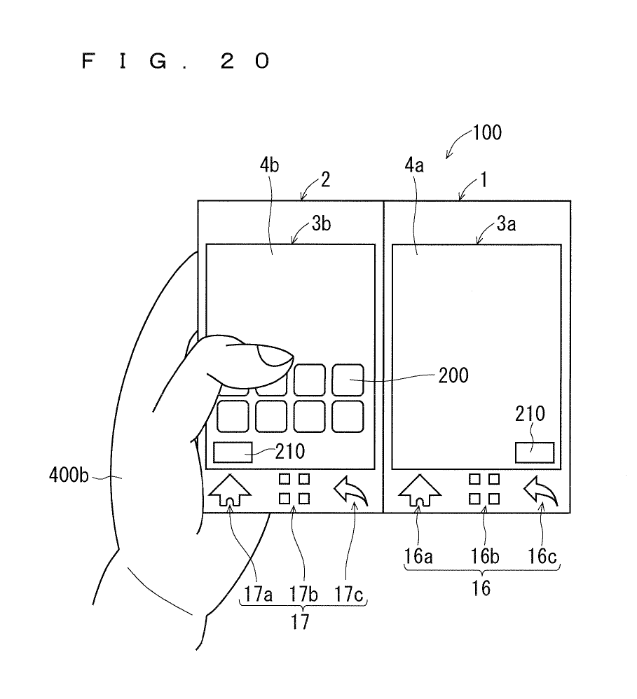

In this manner, the application icons 200 are displayed in the display part 3 provided in one of the first housing 1 and the second housing 2 that is held by the hand of the user. This makes it easy for the user to select the application icon 200 with his/her hand currently holding the portable electronic device 100. As shown in FIG. 19, when the user holds the first housing 1 with his/her right hand 400a, the application icons 200 are displayed in the first display part 3a provided in the first housing 1. This makes it easy for the user to select the application icon 200 with the right hand 400a currently holding the portable electronic device 100. As shown in FIG. 20, when the user holds the second housing 2 with his/her left hand 400b, the application icons 200 are displayed in the second display part 3b provided in the second housing 2. This makes it easy for the user to select the application icon 200 with the left hand 400b currently holding the portable electronic device 100.

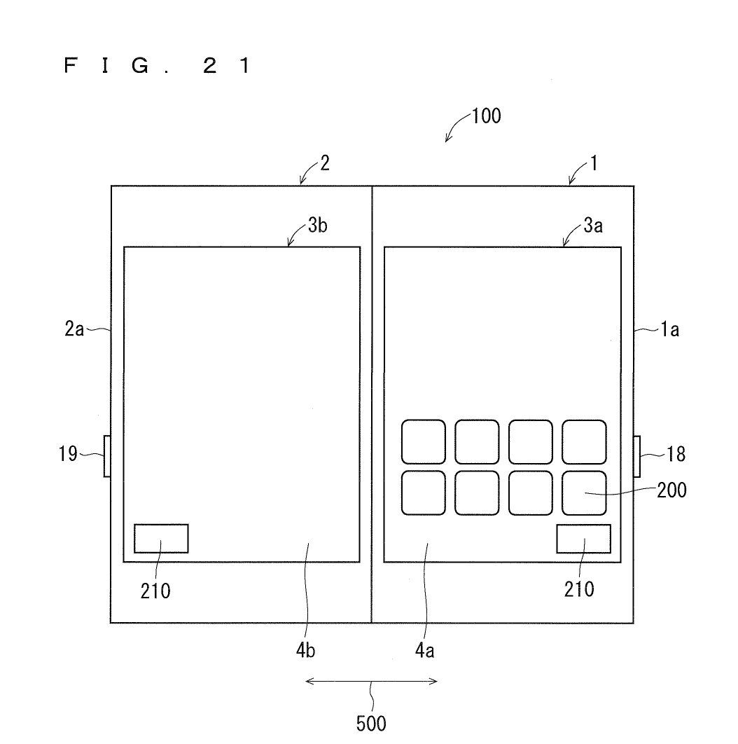

In order to identify which of the first housing 1 and the second housing 2 is held by the hand of the user, for example, a first illuminance sensor 18 mounted in the first housing 1 and a second illuminance sensor 19 mounted in the second housing 2 are provided, as shown in FIG. 21. Each of the first illuminance sensor 18 and the second illuminance sensor 19 detects a luminance therearound.

In the portable electronic device 100 in the open state, the first illuminance sensor 18 is mounted to a side surface 1a of the first housing 1 at the side opposite to the second housing 2 with respect to a direction 500 of a side-by-side arrangement of the first display screen 4a and the second display screen 4b. In the portable electronic device 100 in the open state, the second illuminance sensor 19 is mounted to a side surface 2a of the second housing 2 at the side opposite to the first housing 1 with respect to the direction 500 of the side-by-side arrangement of the first display screen 4a and the second display screen 4b. In the side surface 2a, the above-described third operation part 6 is also provided.

As shown in FIG. 19, when the user holds the first housing 1 with the right hand 400a, a luminance detected by the first illuminance sensor 18 decreases. Therefore, if the luminance detected by the first illuminance sensor 18 is smaller than a threshold value, the control section 12 determines that the user is holding the first housing 1.

On the other hand, as shown in FIG. 20, when the user holds the second housing 2 with the left hand 400b, a luminance detected by the second illuminance sensor 19 decreases. Therefore, if the luminance detected by the second illuminance sensor 19 is smaller than a threshold value, the control section 12 determines that the user is holding the second housing 2.

In this manner, the first illuminance sensor 18, the second illuminance sensor 19, and the control section 12 function as a housing identification section for identifying which of the first housing 1 and the second housing 2 is held by the hand of the user.

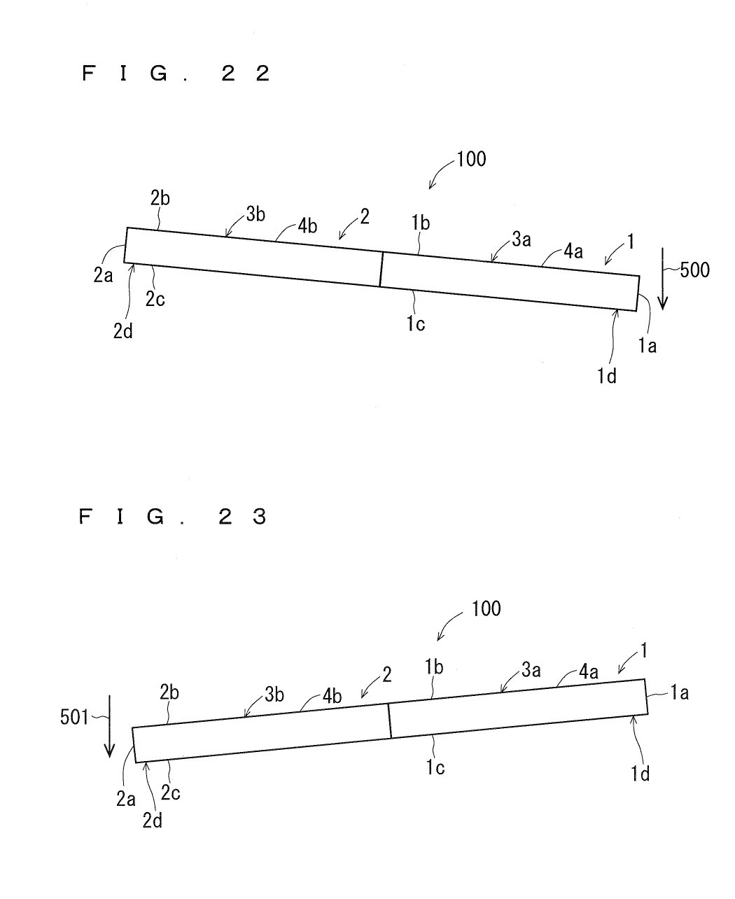

Instead of the first illuminance sensor 18 and the second illuminance sensor 19, a three-axis acceleration sensor may be used. When the user holds the first housing 1 with the right hand 400a as shown in FIG. 19, the first housing 1 tends to be lowered, as shown in FIG. 22. In other words, an end portion 1d of the first housing 1 located at the side surface 1a side tends to move in a direction 500 extending from a main surface 1b of the first housing 1 located at the first display screen 4a side toward a main surface 1c thereof opposite to the main surface 1b. If the control section 12 identifies that the first housing 1 is lowered based on an output signal of the three-axis acceleration sensor, the control section 12 determines that the user is holding the first housing 1.

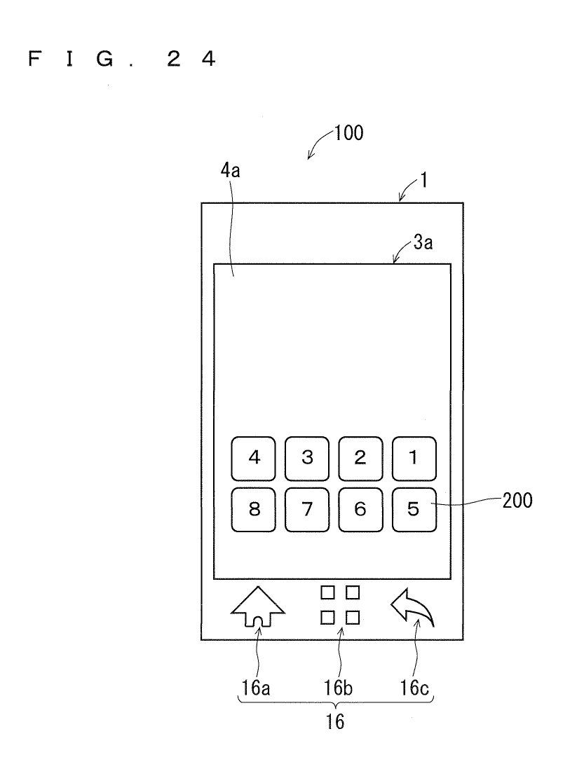

On the other hand, when the user holds the second housing 2 with the left hand 400b as shown in FIG. 20, the second housing 2 tends to be lowered, as shown in FIG. 23. In other words, an end portion 2d of the second housing 2 located at the side surface 2a side tends to move in a direction 501 extending from a main surface 2b of the second housing 2 located at the second display screen 4a side toward a main surface 2c thereof opposite to the main surface 2b. If the control section 12 identifies that the second housing 2 is lowered based on an output signal of the three-axis acceleration sensor, the control section 12 determines that the user is holding the second housing 2.

In order to identify which of the first housing 1 and the second housing 2 is held by the hand of the user, the first illuminance sensor 18, the second illuminance sensor 19, and the three-axis acceleration sensor may be used. That is, if the control section 12 identifies that the luminance detected by the first illuminance sensor 18 is smaller than the threshold value and additionally that the first housing 1 is lowered based on the output signal of the three-axis acceleration sensor, the control section 12 determines that the user is holding the first housing 1. If the control section 12 identifies that the luminance detected by the second illuminance sensor 19 is smaller than the threshold value and additionally that the second housing 2 is lowered based on the output signal of the three-axis acceleration sensor, the control section 12 determines that the user is holding the second housing 2.

In a possible configuration, if the mode switch button 210 displayed in one of the display parts 3 is operated while the control section 12 is operating in the normal icon display mode, the application icons 200 are displayed in the one display part 3, and subsequently, when the home screen is no longer displayed and then the home screen is displayed again, the application icons 200 are displayed in the display part 3 provided in the housing held by the hand of the user at this point of time.

### Second Modification

In the limited-number-of-displayed-icons mode, the user may be allowed to designate the display parts 3 that is to display the application icons 200. More specifically, the user operates at least one of the first display screen 4a and the second display screen 4b, and thereby can designate the display part 3 that is to display the application icons 200 in the limited-number-of-displayed-icons mode. When the user designates the display part 3 that is to display the application icons 200, identify information for identifying the designated display part 3 is stored in the storage section 13. The control section 12 operating in the limited-number-of-displayed-icons mode causes the application icons 200 to be displayed in the display part 3 indicated by the identify information stored in the storage section 13.

### Third Modification

In the limited-number-of-displayed-icons mode described above, a brightness of the display screen 4 of, from among the first display part 3a and the second display part 3b, the display part 3 not displaying the application icons 200 may be lowered. In order to lower the brightness of the display screen 4 of the display part 3, a brightness of the backlight provided in the display part 3 is lowered.

If the brightness of the display screen 4 of the display part 3 not displaying the application icons 200 is lowered in this manner, power consumption of the portable electronic device 100 can be reduced.

Desirably, in lowering the brightness of the display screen 4 of the display part 3, light emission of the backlight is stopped and the display of the display screen 4 is turned off. In such a case, the power consumption of the portable electronic device 100 can be further reduced.

### Fourth Modification

In a possible configuration, if, in a case where the current number of application icons 200 is greater than the predetermined threshold value, the home screen is displayed and the portable electronic device 100 having the control section 12 operating in the normal icon display mode is changed from the open state to the closed state, application icons 200 to be displayed on the first display screen 4a are determined based on the display priorities of the application icons 200 determined depending on the frequency of launching of the correspond applications 130, similarly to the first example for determining the display priority described above. The threshold value adopted in this modification is set to be equal to or less than the number of application icons 200 (in this example, 20 icons) displayable in one display part 3, similarly to the threshold value adopted in the limited-number-of-displayed-icons mode.

For example, it is assumed that the threshold value according to this modification is “8”. If the portable electronic device 100 as shown in FIGS. 6 and 8 is changed from the open state to the closed state in a case where the current number of application icons 200 is greater than “8”, the control section 12 selects, from the application icons 200 to be displayed, eight application icons 200 in descending order of the display priority (that is, eight application icons 200 in descending order of the frequency of launching of the corresponding applications 130). Then, the control section 12 causes these eight application icons 200 to be displayed in the first display part 3a, as shown in FIG. 24.

In a possible configuration, if, in a case where the current number of application icons 200 is greater than the predetermined threshold value, the home screen is displayed and the portable electronic device 100 having the control section 12 operating in the normal icon display mode is changed from the open state to the closed state, application icons 200 to be displayed on the first display screen 4a are determined based on the display priorities of the application icons 200 determined depending on the kind of place where the portable electronic device 100 is located.

If the home key 16a of the first operation part 16 is operated while the first display part 3a is displaying a plurality of application icons 200 having higher display priorities as shown in FIG. 24, the display of the first display part 3a returns to a normal display.

As described above, if the portable electronic device 100 is changed from the open state to the closed state in a case where the number of application icons 200 to be displayed is large, the application icons 200 are displayed in the first display part 3a based on the display priority determined depending of the frequency of launching of the applications 130 or the kind of place where the portable electronic device 100 is located. This makes it easy for the user to select a desired application icon 200.

In this example, too, by scrolling upward the home screen displayed in the first display part 3a, the plurality of application icons 200 to be displayed are displayed in descending order of the display priority. In a case where, as shown in shown in FIGS. 13 and 14 mentioned above, all of the application icons 200 to be displayed can be displayed by switching the page of the home screen, the plurality of application icons 200 to be displayed are displayed in descending order of the display priority by switching the page of the home screen.

### Other Modifications

Although the above-described preferred embodiment illustrates a case where the invention of the present application is applied to a mobile phone, the invention of the present application is also applicable to portable electronic devices other than mobile phones. For example, the invention of the present application is applicable to a portable game console, a notebook personal computer, an electronic book, a portable navigation system, a portable music player, and the like.

The invention of the present application is also applicable to a portable electronic device in which, unlike the above-described portable electronic device 100, two display screens are always simultaneously viewable. The invention of the present application is also applicable to a portable electronic device in which two display screens are simultaneously viewable in the open state while not all of the two display screens are viewable in the closed state. For example, the invention of the present application is applicable to a clamshell mobile phone or a notebook personal computer each of which is foldable such that two housings each having a display screen formed on an inner surface thereof can overlap each other.

While the invention has been shown and described in detail, the foregoing description is in all aspects illustrative and not restrictive. It is therefore understood that numerous modifications and variations can be devised without departing from the scope of the invention.

What is claimed is:

1. A portable electronic device comprising:
a first display part including a touch-panel function and being operable to display an icon for launching an application program;
a second display part including a touch-panel function and being operable to display the icon; and
a display control section for controlling displays in said first and second display parts,
wherein
said display control section performs a display control such that, when the number of the icons to be displayed is greater than a threshold value, a part of the icons to be displayed are simultaneously displayed in one of display screens of said first and second display parts.

2. The portable electronic device according to claim 1, wherein
when a predetermined operation is performed on the one of the display screens in the case where the display screens are simultaneously viewable, said display control section causes the another icon to be displayed in the one of the display screens.

3. The portable electronic device according to claim 1, wherein
said display control section determines the icon which is displayed in the one of said first and second display parts in said display control, based on a display priority.

4. The portable electronic device according to claim 3, wherein
a higher display priority is given to the icon corresponding to the application program more frequently launched.

5. The portable electronic device according to claim 3, further comprising
an identification section for identifying a kind of place where said portable electronic device is located,
wherein, if the kind of place where said portable electronic device is located, which is identified by said identification section, indicates a particular kind, the highest display priority is given to the icon for launching the application program concerning said particular kind.

6. The portable electronic device according to claim 1, further comprising
a first housing provided with the first display part,
a second housing provided with the second display part, and
a housing identification section for identifying which of said first and second housings is held by a hand of a user,
wherein said display control section causes the part of the icons to be displayed in the one of said first and second display part provided in one of said first and second housing that is identified by said housing identification section.

7. The portable electronic device according to claim 1, wherein
said display control section causes the part of the icons to be displayed in the one of said first and second display parts whose display screen has been operated.

8. A portable electronic device comprising:
a first display part including a touch-panel function and being operable to display an icon for launching an application program;
a second display part including a touch-panel function and being operable to display the icon;
a display control section for controlling displays in said first and second display parts; and
a display priority determination section for determining a display priority of the icon based on a frequency of launching of the application program corresponding to the icon;
wherein
said portable electronic device has a first state and a second state, said first state allowing display screens of said first and second display parts to be simultaneously viewed, said second state allowing, from among the display screens of said first and second display parts, only the display screen of said first display part to be viewed,
if said first and second display parts are changed from the first state to the second state in a case where the number of the icons to be displayed is greater than a threshold value, said display control section determines the icon which is displayed in said first display part, based on said display priorities of the icons to be displayed.

9. A portable electronic device comprising:
a first display part including a touch-panel function and being operable to display an icon for launching an application program;
a second display part including a touch-panel function and being operable to display the icon;
a display control section for controlling displays in said first and second display parts;
an identification section for identifying a kind of place where said portable electronic device is located; and
a display priority determination section for determining a display priority of the icon based on the kind of place where said portable electronic device is located, which is identified by said identification section;
wherein
said portable electronic device has a first state and a second state, said first state allowing display screens of said first and second display parts to be simultaneously viewed, said second state allowing, from among the display screens of said first and second display parts, only the display screen of said first display part to be viewed,
if said first and second display parts are changed from the first state to the second state in a case where the number of the icons to be displayed is greater than a threshold value, said display control section determines the icon which is displayed in said first display part, based on said display priorities of the icons to be displayed.
